(19) United States
(12) Patent Application Publication
(10) Pub. No.: US 2004/0253148 A1
(43) Pub. Date: Dec. 16, 2004

(54) Multiple probe expansion (MPX™) accessory device for manual, semi-automated and automated liquid handling equipment federally sponsored research

(76) Inventor: John R. Leaton, Houston, TX (US)

Correspondence Address: John R. Leaton, 13726 Tosca Lane, Houston, TX, 77079, US

(21) Appl. No.: 10/461,471

(22) Filed: Jun. 16, 2003

(51) Int. Cl. B01L 3/02

(52) U.S. Cl. 422/100

(57) ABSTRACT

A mechanical instrumental accessory for liquid handling (FIG. 1A) that can be manually operated or automated (FIG. 1C). Probe spacing distances are not limited as in fixed instruments (FIG. 100). FIG. 7B show a view of the automatic macro MPX™ with a replaceable cam plate (63) that slides up and down a pin adaptor (56) and can be made to move the probes to less than 4.5 mm probe-to-probe for special applications. The MPX™ liquid handling accessory (FIG. 1A) expands and contracts spacing for liquid transfer probes, needles, or tubing to have variable or equal spacing control of the adjacent probes. The interface assembly of the MPX™ liquid handling accessory (FIG. 5) allows a variety of attached sizes of liquid delivery tips and probe types. Cams (62) (FIG. 10A) are replaceable to allow for changes in application requirements.

The device can be of any proportion to use external pumps to aspirate or dispense liquids from micro to macro scale volumes.

### AUTOMATED AND AUTOMATED LIQUID HANDLING EQUIPMENT FEDERALLY SPONSORED RESEARCH

Not Applicable

### SEQUENCE LISTING OF PROGRAM

Not Applicable

### FIELD OF INVENTION

This invention is related to the field of analytical chemistry and specifically to the applications in biotechnology, biochemistry or clinical research and related industrial research functions where there is a requirement for liquid handling in small measured volumes for the purpose of aspirating and dispensing liquid samples in carrying out analytical protocols.

This invention relates to a scientific analytical device whose purpose is used as an accessory product to add to present commercially available instrumentation to enhance the capability of said instrumentation in the process of liquid handling of aspirating and dispensing of liquids, specifically for the positioning of liquids in a clinical, research, and industrial places of business. Application of the invention when manufactured in a larger scale gives the ability to perform liquid handling tasks using ancillary pumps and peristaltic pumps for larger liquid volumes as in the case of filling machines and automated liquid handling instrumentation.

### BACKGROUND—DESCRIPTION OF PRIOR ART

Mechanical devices for liquid handling in aspirating and dispensing measured liquid volumes are used widely in industry, hospitals and research facilities throughout the world. Size of samples varies considerably from nanoliters to gallons, but in laboratory settings typically ranges from a few nanoliters (nl) to several milliliters (ml). Thus, in a typical analytical operation a tubular probe of a measuring device such as a pipet will be inserted into a container for a sample or reagent, and a volume will be aspirated (sucked) into the probe. In the second part of the operation the probe will be withdrawn, moved to the position of a second container, and the sample will be dispensed into that container.

Such devices are designed so that single or muliple channel measuring instruments, referred to as pipetors or multi-channel pipettors can transfer liquids from containers of one size to containers of another size. Single channel units can accomplish the required liquid transfers, but use of these is a laborious process. In a complex analytical procedure typical of many fields of chemistry, biology and biotechnology this operation must be performed hundreds of times across replicate samples and across multiple aspiration-transfer—dispense sequences. Typically the containers consist of large geometric arrays of very small volume vessels. Because of the number of samples, or the number of repetitions that have to be performed, multiple channel pipettor units were designed to give higher throughput and reduce time required for the task Therefore, inventors and manufacturers have created instruments for multiple channel or multiple probe liquid handling that are able to aspirate, transfer and dispense liquids from 1 to 16 channels, or more, at once. Attached to each individual channel or probe is a disposable tip, or needle. In the case of automated equipment, disposable tips or needles are attached to each individual probe.

Such devices and instruments have the following disadvantages:

(a) Probes with needles or diposable tips are equally spaced on 9 mm centers. The probes are fixed in position and cannot be changed. This arrangement works well as long as all transfers are made between vessels spaced at the same distances. However, analysts may wish to transfer from a test tube to a microplate. A microplate is a small flat molded plastic plate having an array of small depressions, called microwells that are in a regular array. One typical microplate has a rectangular array of microwells 8 rows wide by 12 long to form a 96 well plate, each well spaced at a distance of 9 mm and holding a volume of approximately 300 microliters (ul). Another typical microplate halves to 4.5 mm the distance between the microwells to achieve a 16 by 24 array of 384 microwells. If the analyst wishes to transfer samples from a 96 well plate to the 384 well plate the task becomes tedious and time consuming with a high probability for errors.

(b) Manufacturers of laboratory robots have standardized 9 mm spacing between probes of all available equipment. When transferring samples between the 96 well plates and the 384 well plates it is necessary with the fixed probes to interweave and transfer to alternate wells.

(c) The practice of interweavimg (interdigitating) presents difficulties in experiment design, and as well, there are often mistakes in proper placement of sample probes in the targeted well because the sample is clear and difficult to see.

(d) Automated systems, laboratory robots and general liquid handling equipment do not allow the automatic changing from one probe spacing to another without the expense of an additional integrated system or one that has to be halted in process for manual change of probe spacing or position

(e) Automated systems and liquid handling equipment cannot vary the spacing between probes to less than 4.5 mm

(f) filling machines and specialized equipment that utilize different size containers or transfer liquid from one size container to another use special fixed probe configurations and must have installed a variable span of probes for different applications.

The Matrix technologies Corp., Hudson N.J. manufactures a mechanical hand-held liquid handling device which allows transfer of liquids from tubes to microplates. This prior art does allow spacing of probes to 384 well plates, but does not accommodate any vessels with spacing less than 4.5 mm. It does not expand to larger tubes or spacings beyond its built-in capacity. The Matrix pipettor is one complete unit and therefore cannot be offered as an add-on to other laboratory automated robots.

Automated equipment for transferring liquid from a large container to a small container has also been manufactured. Problems still exist in that while the change of spacing can be done mechanically no spacing less than 9 mm is available. The automated arm is very expensive, and like the small hand held devices is available only through the manufacturer as an integrated item of equipment. The main problem existing in the instruments described above is that they are integrated systems and one cannot purchase at reasonable cost an accessory to retrofit onto the present equipment to serve a needed application

### OBJECTS AND ADVANTAGES

The present invention of the MPX accessory is a solution to the many analytical liquid handling applications which require changes in sample probe spacing. This invention does not require the replacement of components of the original equipment. Several objects and advantages of the present invention are:

(1) to provide an accessory device that can be attached or retrofitted onto present existing hand-held liquid pipettors.

(2) to provide an accessory device to a hand-held or robotic instrument that can be controlled by a computer or switch-controlled mechanism within the automated equipment.

(3) to provide an accessory to hand-held liquid pipettors or automated equipment to allow probes, needles or disposable tips to be varied from a larger spacing to a spacing less than than 4.5 mm.

(4) to provide an accessory device that can be easily attached to present equipment without having to purchase specific integrated assemblies or systems for the present equipment.

(5) to provide an accessory device for hand-held liquid handling pipettors or automated equipment that can be altered to change from one custom spacing of probes to another spacing different from that of the original with only the exchange of readily available small hardware components.

(6) to provide an accessory device for hand-held liquid pipettors or automated equipment that can have different probe-to-probe spacing based upon use of a variable cam mechanism.

(7) to provide an inexpensive solution to an expensive problem, i.e., the ability to quickly and simply install an inexpensive accessory device to already purchased equipment thus enhancing the functionality of the equipment.

(8) to provide an accessory device that can address both small volume and large volume liquid sample handling applications;

(9) to provide an accessory device that can be added to small pumps for dispensing of liquids from small to larger containers or vice versa.

(10) further objects and advantages will become apparent from consideration of the ensuing description and drawings.

### SUMMARY

In accordance with the present invention, a mechanical accessory which may be attached to existing commercially available hand-held liquid handling pipettors and liquid handling automation equipment comprises a instrument with an enhanced capability for liquid sample manipulation by varying the spacing of sampling probes from large to small distances

### DRAWINGS (SEE ATTACHED SHEETS)

Drawing Figures

In the drawings, closely related figures have the same number but different alphabetic suffixes and the complete assembly has a description designated by a figure (fig) number with subsections described by numerical numbers.

FIG. 100 shows a representive sample of a commercially available mechanical hand-held liquid handling pipetting device.

FIG. 1A-1D shows perspective views of the invention. FIG. 1B. invention attached to the hand-held liquid handling pipetting device, FIG. 1C automated model of the invention for large applications front side

FIGS. 2A to 2B show an electronic controller for the invention.

FIGS. 3A to 3B show the invention with protective cover removed in the expanded mode and the compressed mode and two sample plates of 96 individual wells and 384 wells.

FIGS. 4A to 4B shows an arm attached to an automated model of the invention.

FIG. 5 show an exposed view of the working model of the invention as an accessory for the hand-held liquid handling instrument using (providing) a variable spacing of the probes.

FIG. 6 shows a detailed description of a working interface and moving parts of the invention for the hand-held liquid handling pipettor.

FIGS. 7A-7B shows a detailed description of a working interface and moving parts of an automated model (embodiment?) of the invention and a semi-automated macro version of the invention. FIGS. 8A to 8B shows end views of disposable probe and needle holders.

FIG. 9 shows an assortment of needles and probes

FIGS. 10A to 10B shows perspective views of the cams and cam plates of the invention.

FIGS. 11A to 11C shows perspective views of tubing, and small and large interfaces.

FIG. 12 shows details of the large tubing holder and the air cylinder plate assembly.

### REFERENCE NUMERALS TO DRAWINGS

11 Needles

20 Original Hand-Held Liquid Handling Pipetting Device

30 MPX™ (Multiple-Probe-Expansion) Invention

31 Protective Cover

40 Micro Interface

41 Macro Interface

42 Disposable Plastic Tip

43 Tubing

44 Probe Holder

45 Disposable Tip adaptor

46 Small Pin

48 Carrier rod hole

49 Small Rod Guide

50 MPX™ Automatic Model (Macro)

51 Screwhole

52 End Plate

54 Large Probe Holder

55 Needle Holder

56 Large Pin

57 Pneumatic Cylinder

59 Large Rod Guide

60 Small Plate Holder

61 Large Plate Holder

62 Small Cam

63 Large Cam

70 MPX Automatic Model (Micro)

80 Electronic Controller

81 Cylinder Plate

82 Tube Holder

### DETAILED DESCRIPTION

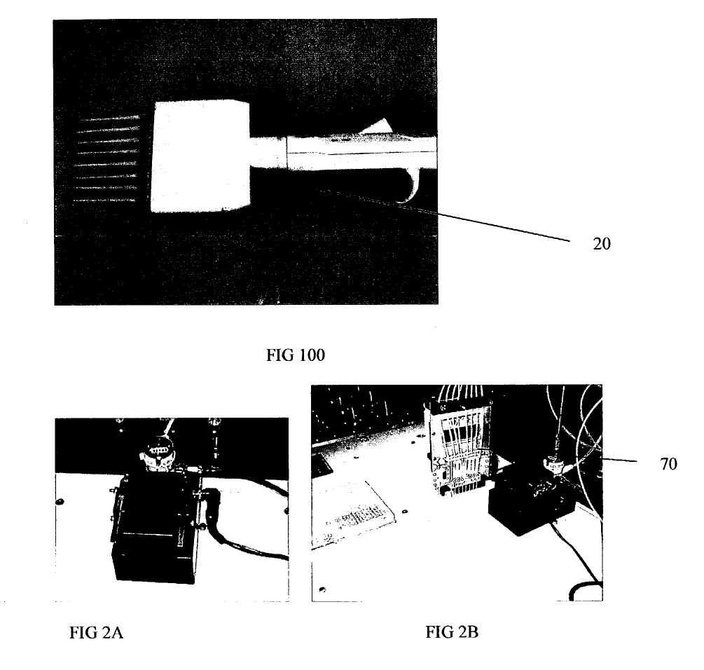

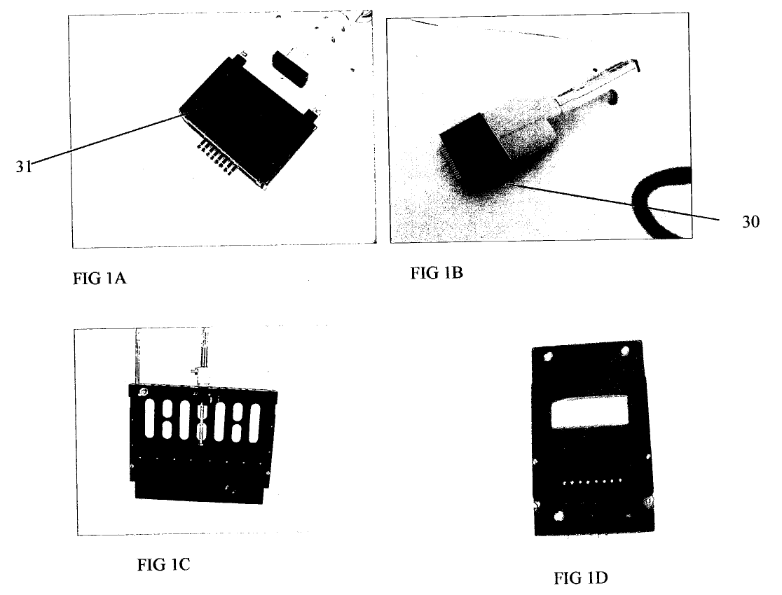

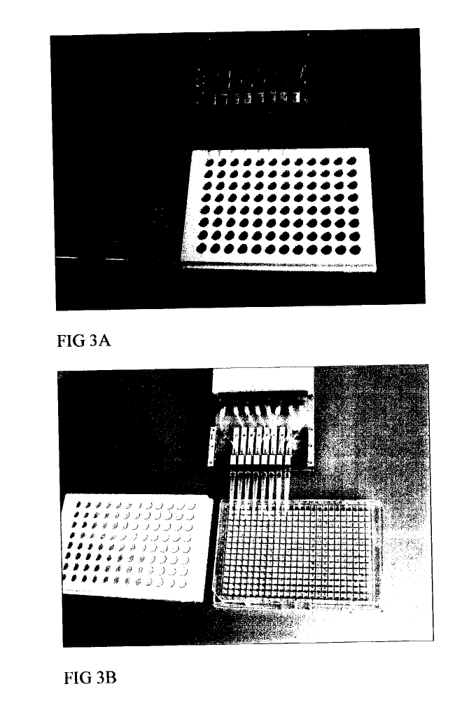

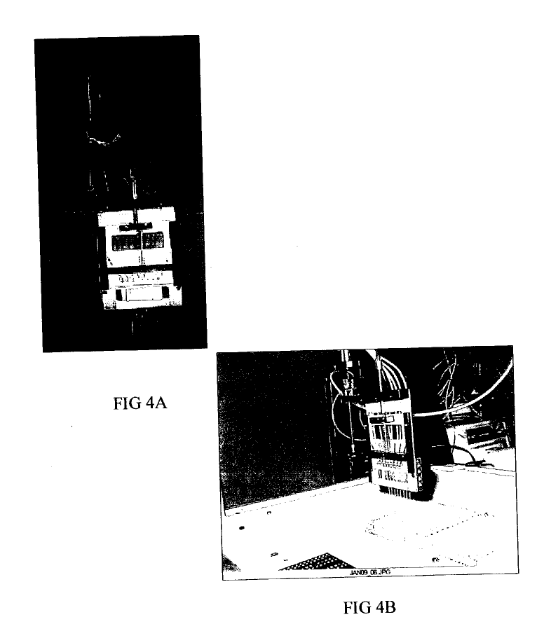

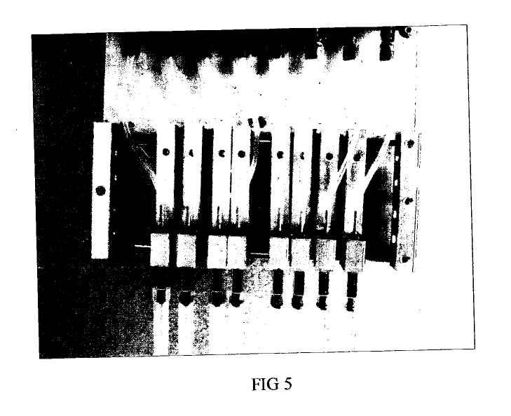

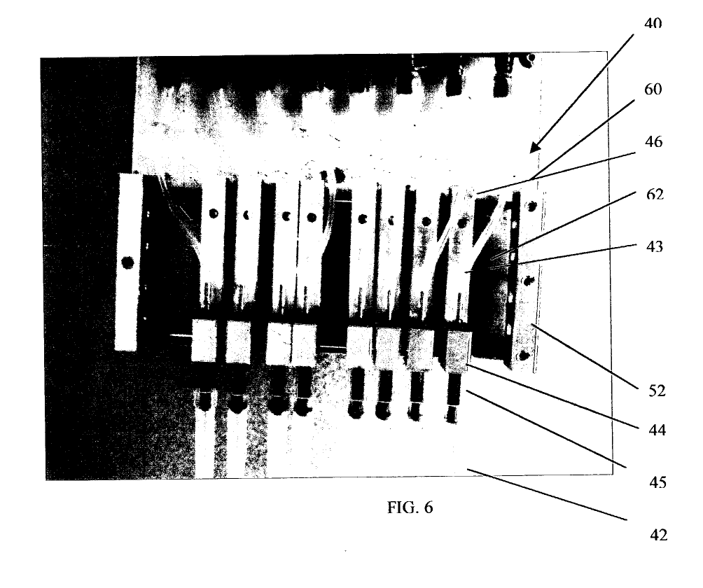

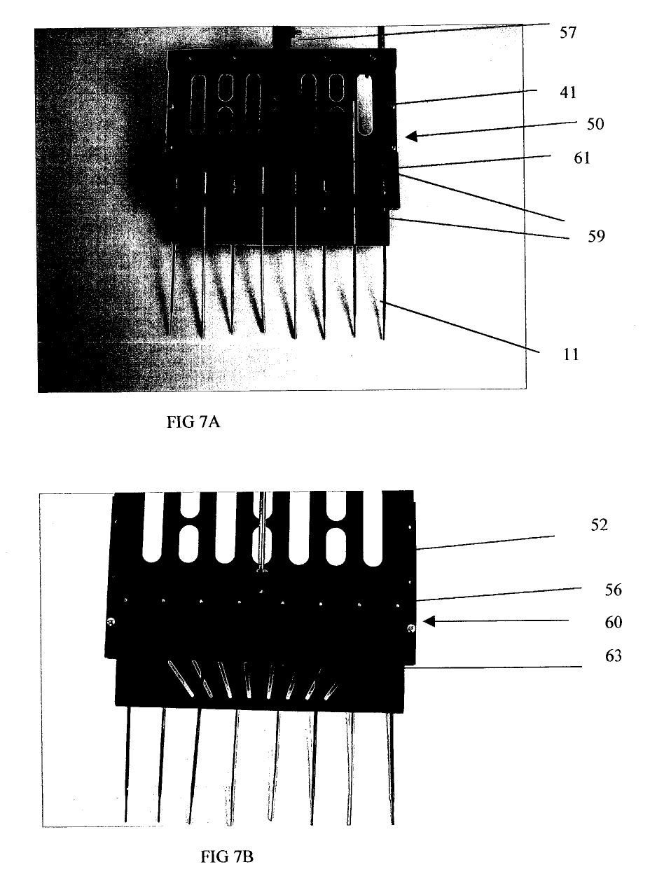

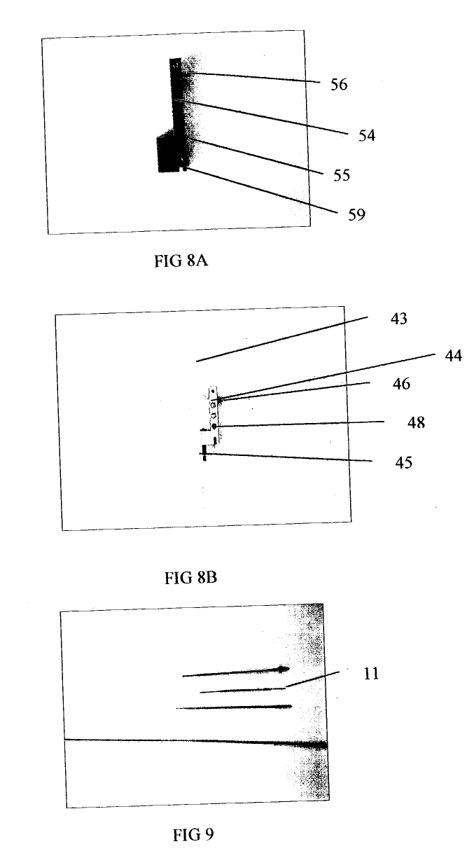

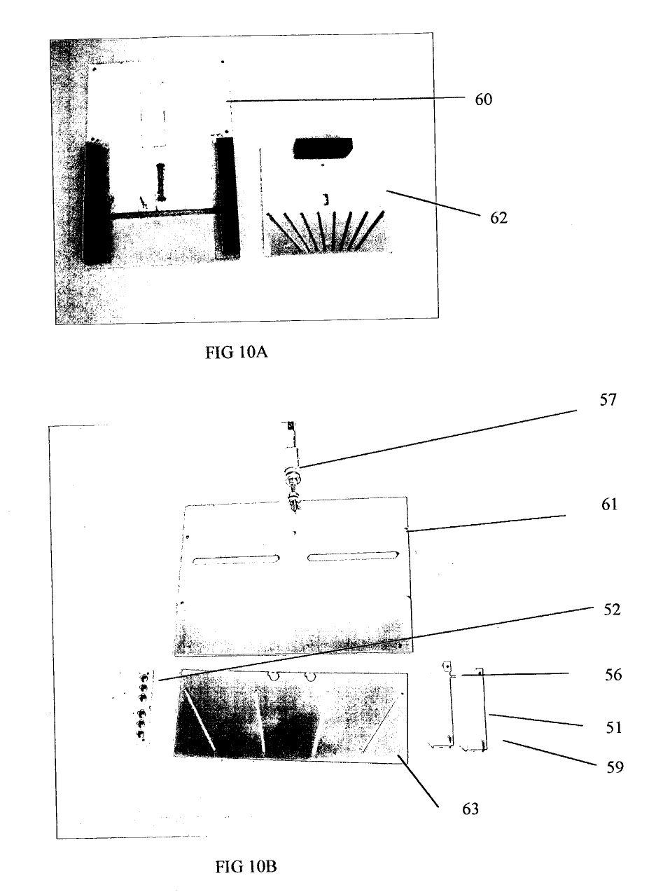

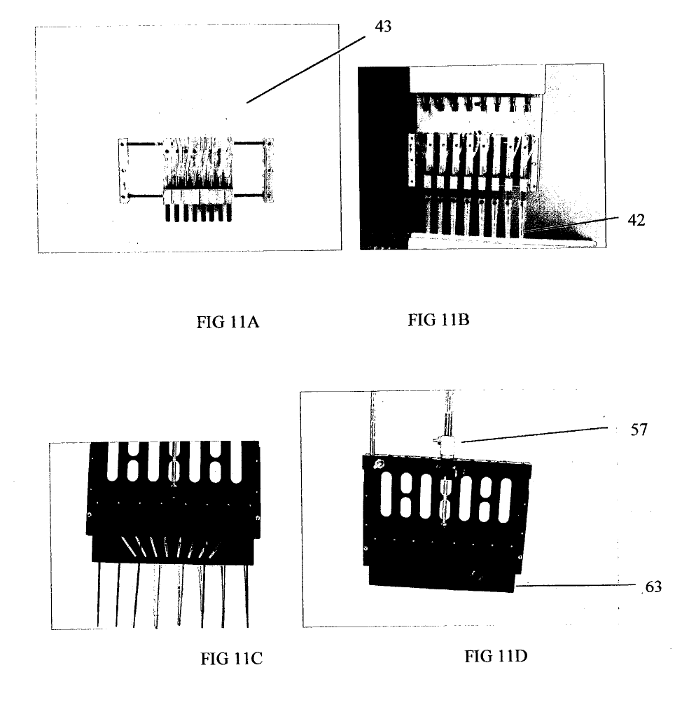

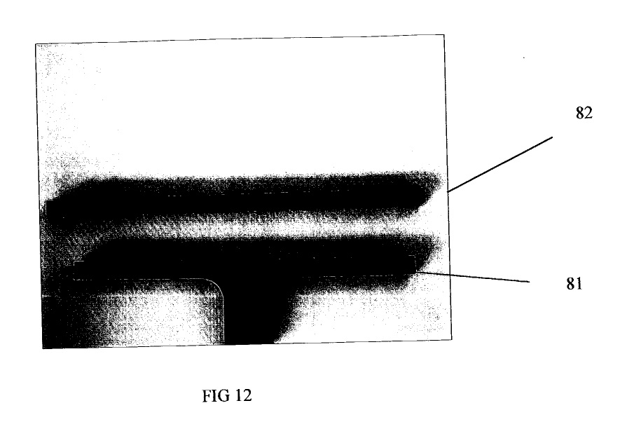

A preferred embodiment of the present invention is illustrated in FIG. 100 which is attached to 30 and in an automated version as illustrated in FIGS. 1C and 1D. FIG. 100 is an illustration of a commercially available hand-held liquid handling device. Described below are illustrative parts and mechanisms of the hand-held liquid handling device and the automation device.

FIG. 1A shows an illustration of the attached invention with a protective cover 31 and the MPX™ Invention 30. Protective cover 31 is attached with 4 screws to a small plate holder 60

FIG. 6 shows an illustration of the integral working parts of the MPX™ invention.

Tubing 43 is attached to the original hand held liquid handling pipetting device 20 then onto individual probe holders 44 which may have many disposable tip adaptors 45 or have needles attached as illustrated in FIG. 7A.

FIGS. 8A and 8B shows an illustration of the detail of the individual probe holders 44 showing the locator pin 46 at the top of the probe holder. These individual pins 46 rest and align in slots in a small cam plate 62 that slides against 60 small plate holder. Carrier rod guides 48 rest in a groove in the under side of probe holder 44 and also at the top of probe holder 44. Press fit into the probe holder 44 are disposable tip adaptors 45 and disposable tips 42. FIG. 9 shows an illustration of different sized needles that can replace the disposable tips 42.

FIG. 6 shows an illustration of end plates 52 attached to a small plate holder 60

FIGS. 7A-7B shows illustrative views of an automated invention 50. Tubing from the automated liquid handling equipment is attached through the tube holder 82 to needles 11 connected to individual probe holders 54 which may have many disposable tip adaptors 45 or have needles 11 attached as illustrated in FIG. 1C.

FIG. 7A, FIG. 8A show an illustration of the detail of the individual probe holders 54 showing the locator pin 56 at the top of the probe holder. Individual pins 56 rest and align in a large cam 63 that slides against 61 small plate holder. Carrier rod guides 59 rest in a groove in the under side of probe holder 54 and also at the top of probe holder 54.

FIG. 9 shows an illustration of different sized needles, which can replace the disposable, tips 42.

FIG. 7B shows an illustration of end plates 52 attached to the large plate holder 60 Needles 11 are attached by small screws in screw holes 51

FIG. 7A illustrates the attachment of pneumatic air cylinder 57 to cylinder plate 81 illustrated in FIG. 12 attached to end plate 52

Advantages

From the description above, a number of advantages of my invention become evident:

(a) The need to enhance the capability of existing and future liquid handling instrumentation is easily done by attaching the small probe expansion device.

(b) The attachment of the automated device to a large liquid handling robotic instrument adds flexibility to the instrument.

(c) Different size needles and probes can be added to the probe holders.

(d) Different spacing from needle to needle or probe to probe is available to the scientist's application.

(e) Replaceable cams, which determine the spacing of the probes, can be easily installed without having to purchase a second instrument.

(f) Automation of the spacing can be done electronically, from a switch controlled internally by a computer, or by an external switch which actuates a pneumatic cylinder, which raises and lowers the plate containing the pins up and down the cam thus changing the spacing of the probes.

(g) Difficult liquid handling applications can now be done with either the manual accessory for hand held liquid pipettors or automated liquid handling instrumentation.

(h) Different size tubing can be used with a combination of different sized probes or needles.

Operation—FIGS. 1 to 12

The procedure of transferring liquids from one container to another albeit being whether smaller or larger is an important part of the analytical or manufacturing process when using research fluids, pharmaceutical products, industrial products, or clinical samples. It is very desirable in this process, to reduce and eliminate mistakes, to improve productivity, and reduce labor time. In today's world of new genetic discoveries, the use of hand-held and automated liquid handling instrumentation is important as less liquid is used and transferred, but to more and more plates and microwells. Storage of such samples is important to future libraries of genetic reference information and is usually kept in controlled environments. Technology of hand-held liquid handling pipettor instruments and automated liquid handling equipment is being challenged to meet the demands of today's bio-technology.

FIGS. 1A to 1D, illustrates a representation of a commercially available liquid handling pipettor that can be modified by adding an accessory to enhance the capability of the original device. Both the hand-held and automated liquid handling systems, by their own operation have the ability to aspirate or pull up liquid into small needles or disposable tips, then transfer them or dispense the liquid to a given container. In FIGS. 3A and 3B, the addition of the expansion probe assembly allows the scientist to transfer liquid from a 96 well plate to a secondary 384 well plate which is four times more dense that the 96 well plate, by manually moving the handle on the small plate holder 60 to the closed position to meet the required spacing of the wells on the 384 well plate. The procedure is reversed by raising the cam plate to the full open position of the probes to take the sample again from the larger plate. The interface mechanism tubing 43 is connected so that it is flexible to move with the spreading of the probes or when the probe are again closed to a narrower spacing and also maintains an air tight seal from the original end fittings on the original liquid handling device to the receptor pins on the probe holders 44.

The cam 62 and plate holder 60 act in unison with cam 62 or cam 63 with plate 61 so that the angle of the machined out area in plate 60 or plate 61 has the desired computer designed angle to facilitate the correct movement of the desired spacing of the probe or probes.

Pins 46 and pins 56, attached to probe holders 44 or 54 act as guides for the cam 62, or cam 63, which follow the path of the machined grooved area in the cam. Needles 11 or probes can be changed easily to change to the desired application as the hole size can be adjusted to fit the required application. Disposable tips 42 are removed and new tips are replaced onto tip adaptors 45 between liquid samples.

An automated model of the invention, cam 63 and plate holder 61 have an actuation by movement of an air cylinder 57 to a bidirectional direction movement of the cam. Movement back and forth of the probes can be automatically accomplished by actuation of the solanoid from signals from within the computer's program to the switch FIG. 2A. The switch can be electronically controlled by TTL logic within the computer or by other external event controls.

When using the switch as illustrated in FIG. 2A the automated arm actuates the switch by pushing on one of the protruding toggle arms on the switch. One arm is used to turn the device to the “closed” position of the probes, the second arm to open the probes to their extended position.

Movement of the large macro model of the above is accomplished by the identical action of the smaller mechanism with the exception of how the cam 63 is moved up and down.

### CONCLUSION, RAMIFICATION, AND SCOPE

Accordingly, the reader will see that the MPX™ accessory invention can be used to solve many of today's analytical, industrial, and research applications in the many attributes of the invention as discussed below:

(a) use of the MPX™ invention can be applied to both micro and macro amounts of fluids by liquid handling instruments.

(b) Flexibility of present instrumentation can be enhanced and used to better productivity.

(c) Lower Labor costs and higher throughput of liquid handling can be achieved with the invention.

(d) Variability is not reduced to simple applications for probe movements; rather the use of needles configured to meet the application can be used in specialty applications that were not possible before.

(e) Provides an immediate change to present equipment which can be installed easily.

(f) Spacing can be custom ordered to special applications requiring unique probe-to-probe spacing. Tube to plate applications and plate-to-plate applications can be done by the invention reducing the probability of making liquid handling errors.

(g) Well to well liquid transfers are numerically corresponding between low and high density plates i.e., able to be transferred to wells 1-8 in recipient plates in the closed position of the device.

The description of the above and subsequent sections of this submission should not be construed as limiting the scope of the invention but as merely providing illustrations of some of the presently preferred embodiments of this invention.

I claim:

1. A device used as an accessory for liquid handling equipment, comprising:
(a) a plurality of orifices, openings, connectors in a fixture to hold needles, probes, or tubes each having set spacing characteristics from each other and,
(b) the device connected to a separate liquid handling instrument by a tubing mechanism, whereby each tube is connected to a port on the liquid handling instrument, and
(c) the spacing of each liquid handling probe, needle or tube can be variably changed from each adjacent probe, needle, or tube by a movement of designed metal slots against a moving plate, whereby,
(d) said plate can be manufactured to vary the movement of the needle, probe, or tubes to vary the distance by replacement add-on plates to add flexibility to the device, and
(e) the controlling mechanism can control spacing of one or more needles, probes, or tubes to a different spacing from one or more adjacent needles, probes, or tubes and,
(f) the probe holding device which is not restricted to size of needles, probes, or tubes, whereby,
(g) the device made of metal and plastic components such that integration of said components have freedom of movement and stability, and
(h) by means of movement of components along a stabilizer rod to give strength and support and,
(i) the device can be sized in dimension for different scale application requirements.

2. A device as in claim 1 whereby,
(a) the components to actuate the movement of the needles, probes, or tubes can be automated by addition of a pneumatic cylinder or motor driven device, and whereby,
(b) the device can be attached to a robotic or automated liquid handling instruments with X, Y, Z movements and,
(c) the device can be attached to large liquid handling equipment with automated, manual, or semi-automated control and,
(d) the automation components have means of controlled actuation by electronic means, and,
(e) the use of a computer aided controller
